(19) United States
(12) Patent Application Publication
(10) Pub. No.: US 2021/0005864 A1
(43) Pub. Date: Jan. 7, 2021

(54) CONNECTING ASSEMBLY AND BATTERY PACK

(71) Applicants: JIANGSU CONTEMPORARY AMPEREX TECHNOLOGY LIMITED, Liyang City (CN); CONTEMPORARY AMPEREX TECHNOLOGY CO., LIMITED, Ningde (CN)

(72) Inventors: Fan ZHANG, Liyang City (CN); Xiaoshan DAI, Liyang City (CN); Yuchao CHEN, Liyang City (CN)

(21) Appl. No.: 16/551,480

(22) Filed: Aug. 26, 2019

(30) Foreign Application Priority Data
Jul. 5, 2019 (CN) 201921051788.3

(51) Int. Cl. H01M 2/20

(52) U.S. Cl. CPC H01M 2/206; H01M 2220/20

(57) ABSTRACT

The present disclosure provides a connecting assembly and a battery pack, the connecting assembly comprises a busbar, a first insulating sleeve, a second insulating sleeve and a third insulating sleeve. The busbar comprises a main body portion, an extending portion, and a bent connection portion. The first insulating sleeve covers the main body portion. The second insulating sleeve covers the extending portion. The third insulating sleeve comprises a first covering portion, the first covering portion covers the bent connection portion. Because the first insulating sleeve, the second insulating sleeve and the third insulating sleeve are independent components, and they segmentally cover different parts of the busbar, so that each of them has a shorter length and less portion required to be bent, thereby facilitating the first insulating sleeve, the second insulating sleeve and the third insulating sleeve to be respectively sheathed on the different parts of the busbar.

### CROSS-REFERENCE TO RELATED APPLICATIONS

The present application claims priority to Chinese patent application No. CN201921051788.3, filed on Jul. 5, 2019, which is incorporated herein by reference in its entirety.

### FIELD OF THE PRESENT DISCLOSURE

The present disclosure relates to the field of battery technology, and particularly relates to a connecting assembly and a battery pack.

### BACKGROUND OF THE PRESENT DISCLOSURE

With the development of the new energy automobile industry, the capacity and voltage of the battery pack are getting higher and higher, and the arrangement of the battery pack is becoming more and more compact. Correspondingly, requirement on the insulation withstand-voltage reliability of the busbar inside the battery pack is also getting higher and higher. At present, in order to ensure the insulation withstand-voltage reliability of the busbar, an integral heat shrinkable tube is usually sheathed on the busbar, or an insulating layer is disposed on the whole outside of the busbar by a powder spraying, dip molding or extrusion process.

However, because the busbar inside the battery pack has a relative long length, a complicated extension, and has various forms such as a horizontal bending structure, a vertical bending structure, a twisting structure and the like, and when the busbar is insulated with the integral heat shrinkable tube, because the integral heat shrinkable tube at the bending position of the busbar easily generates the defects such as whiteness, wrinkles, air bubbles, tearing and the like, so that it cannot meet the insulation withstand-voltage reliability requirement of the battery pack; when the busbar is insulated by the powder spraying, dip molding or extrusion process, the material cost and process cost are high.

### SUMMARY OF THE PRESENT DISCLOSURE

In view of the problem existing in the background, an object of the present disclosure is to provide a connecting assembly and a battery pack, the structure of the connecting assembly is simple, the manufacturing cost of the connecting assembly is low, and the insulation withstand-voltage reliability of the connecting assembly is high, when the connecting assembly is applied in the battery pack, the connecting assembly can meet the insulation withstand-voltage reliability requirement of the battery pack.

In order to achieve the above object, the present disclosure provides a connecting assembly, which comprises a busbar, a first insulating sleeve, a second insulating sleeve and a third insulating sleeve. The busbar comprises a main body portion, an extending portion, and a bent connection portion, the bent connection portion connects the main body portion and the extending portion. The first insulating sleeve covers the main body portion of the busbar.

The second insulating sleeve covers the extending portion of the busbar. The third insulating sleeve comprises a first covering portion, and the first covering portion covers the bent connection portion of the busbar.

The first insulating sleeve, the second insulating sleeve and the third insulating sleeve each are a heat shrinkable tube.

The third insulating sleeve is wholly located between the first insulating sleeve and the second insulating sleeve.

The third insulating sleeve further comprises a second covering portion, and the second covering portion is connected to the first covering portion and covers a part of the first insulating sleeve.

The third insulating sleeve further comprises a third covering portion, and the third covering portion is connected to the first covering portion and covers a part of the second insulating sleeve.

The extending portion is formed as a rectangular structure. Correspondingly, the second insulating sleeve is also formed as a rectangular structure, and the second insulating sleeve covers a part of the extending portion.

The extending portion comprises a straight section, a bent connection section and an extending section, the straight section is connected to the bent connection portion, the bent connection section connects the straight section and the extending section. The second insulating sleeve comprises a fourth covering portion and a fifth covering portion, the fourth covering portion covers the straight section of the extending portion, the fifth covering portion covers the bent connection section of the extending portion.

The busbar further comprises a connecting hole, and the connecting hole is provided through the extending portion.

The present disclosure further provides a battery pack, which comprises a first battery module, a second battery module and the connecting assembly described above, the first battery module is electrically connected to the second battery module via the connecting assembly.

The first battery module comprises a plurality of first batteries, a first output connecting piece and a first end plate, and one end of the first output connecting piece is electrically connected to the plurality of first batteries, the other end of the first output connecting piece is supported on the first end plate and electrically connected to the busbar. The second battery module comprises a plurality of second batteries, a second output connecting piece and a second end plate, and one end of the second output connecting piece is electrically connected to the plurality of second batteries, the other end of the second output connecting piece is supported on the second end plate and electrically connected to the busbar.

The present disclosure has the following beneficial effects: in the connecting assembly, because the first insulating sleeve, the second insulating sleeve and the third insulating sleeve are independent components, and the first insulating sleeve, the second insulating sleeve and the third insulating sleeve segmentally cover different parts of the busbar, so that the first insulating sleeve, the second insulating sleeve and the third insulating sleeve each have a shorter length and less portion required to be bent, thereby facilitating the first insulating sleeve, the second insulating sleeve and the third insulating sleeve to be respectively sheathed on the different parts of the busbar, therefore the structure of the first insulating sleeve, the second insulating sleeve and the third insulating sleeve are simplified, and the manufacturing cost is greatly reduced. After the first insulating sleeve, the second insulating sleeve and the third insulating sleeve to be respectively sheathed on the different parts of the busbar, because the first insulating sleeve, the second insulating sleeve and the third insulating sleeve each have insulation property, and the first insulating sleeve, the second insulating sleeve and the third insulating sleeve each have a shorter length and less portion required to be bent, in the process that the different parts of the busbar are respectively sheathed with the first insulating sleeve, the second insulating sleeve and the third insulating sleeve, it reduces the wearing of the first insulating sleeve, the second insulating sleeve and the third insulating sleeve caused by the busbar, thereby improving the insulation withstand-voltage reliability of the entire connecting assembly, and in turn ensuring that the connecting assembly satisfies the insulation withstand-voltage reliability requirement of the battery pack.

### BRIEF DESCRIPTION OF THE FIGURES

FIG. 1 is a perspective view of a battery pack of the present disclosure.

FIG. 2 is a perspective view of a connecting assembly of FIG. 1.

FIG. 3 is a schematic view showing a position relationship of a busbar, a first insulating sleeve, a second insulating sleeve and a third insulating sleeve of the connecting assembly.

FIG. 4 is a perspective view of the third insulating sleeve and the busbar of FIG. 2 before assembling, in which the first insulating sleeve and the second insulating sleeve have been mounted on the busbar.

FIG. 5 is a perspective view of the busbar.

FIG. 6 is a variation of FIG. 1.

FIG. 7 is another variation of FIG. 1.

### REFERENCE NUMERALS IN FIGURES ARE REPRESENTED AS FOLLOWS

1 connecting assembly
11 busbar
111 main body portion
112 extending portion
112A straight section
112B bent connection section
112C extending section
113 bent connection portion
114 connecting hole
12 first insulating sleeve
13 second insulating sleeve
131 fourth covering portion
132 fifth covering portion
14 third insulating sleeve
141 first covering portion
142 second covering portion
143 third covering portion
2 first battery module
21 first output connecting piece
22 first end plate
3 second battery module
31 second output connecting piece
32 second end plate
X transversal direction
Y longitudinal direction
Z up-down direction

### DETAILED DESCRIPTION

To make the object, technical solutions, and advantages of the present disclosure more apparent, hereinafter the present disclosure will be further described in detail in combination with the accompanying figures and the embodiments. It should be understood that the specific embodiments described herein are merely used to explain the present disclosure but are not intended to limit the present disclosure.

In the description of the present disclosure, unless otherwise specifically defined and limited, the terms “first”, “second”, “third” and the like are only used for illustrative purposes and are not to be construed as expressing or implying a relative importance; the term “plurality” means two or more; the terms “connect” should be broadly interpreted, for example, the term “connect” can be “fixedly connect”, “detachably connect”, “integrally connect”, “electrically connect” or “signal connect”. The term “connect” also can be “directly connect” or “indirectly connect via a medium”. For the person skilled in the art, the specific meanings of the abovementioned terms in the present disclosure can be understood according to the specific situation.

In the description of the present disclosure, it should be understood that spatially relative terms, such as “above”, “below” and the like, are described based on orientations illustrated in the figures, but are not intended to limit the embodiments of the present disclosure. Hereinafter the present disclosure will be further described in detail in combination with the figures.

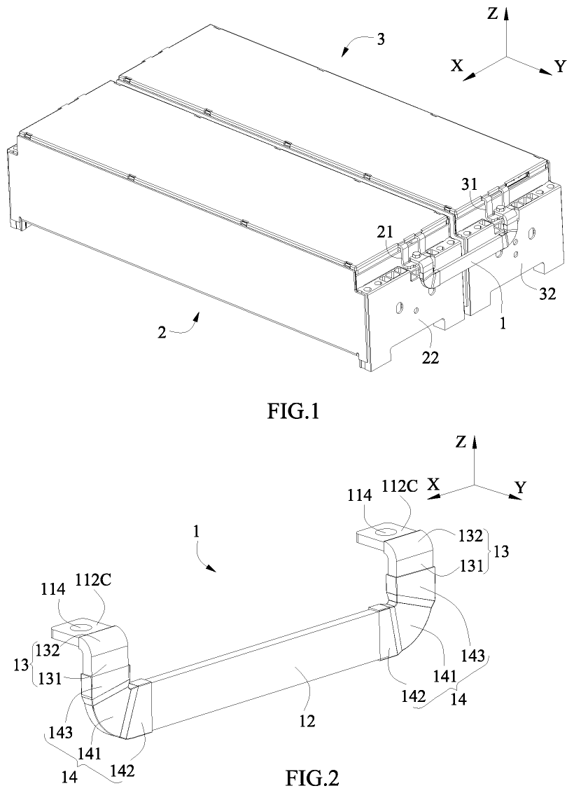

Referring to FIG. 1, a battery pack of the present disclosure may comprise a connecting assembly 1, a first battery module 2 and a second battery module 3. The first battery module 2 and the second battery module 3 are arranged side by side in a transversal direction X, and the first battery module 2 is electrically connected to the second battery module 3 via the connecting assembly 1.

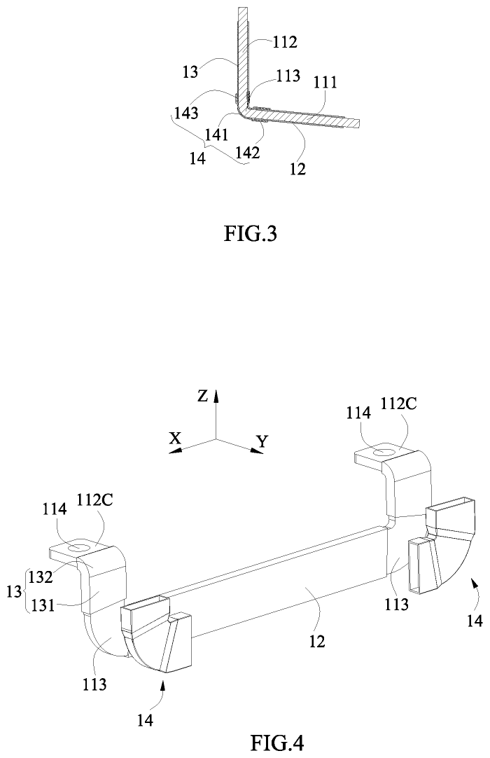

Referring to FIG. 2 to FIG. 7, the connecting assembly 1 may comprise a busbar 11, a first insulating sleeve 12, a second insulating sleeve 13 and a third insulating sleeve 14.

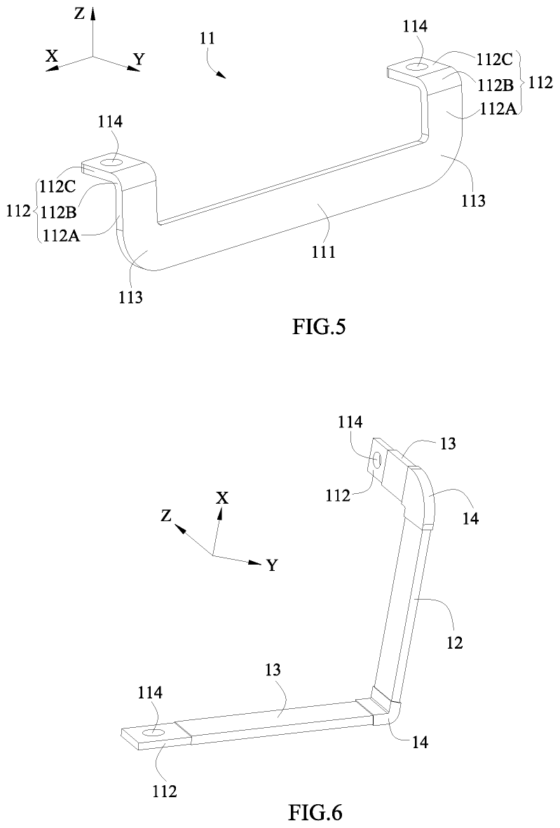

The busbar 11 may be made of a conductive material, such as copper, aluminum, nickel, and alloys thereof. Referring to FIG. 5, the busbar 11 may comprise a main body portion 111, an extending portion 112, a bent connection portion 113 and a connecting hole 114. The bent connection portion 113 connects the main body portion 111 and the extending portion 112, and the connecting hole 114 is provided through the extending portion 112.

Referring to FIG. 2 and FIG. 4, the first insulating sleeve 12 covers the main body portion 111 of the busbar 11. The second insulating sleeve 13 covers the extending portion 112 of the busbar 11. The third insulating sleeve 14 may comprise a first covering portion 141, and the first covering portion 141 covers the bent connection portion 113 of the busbar 11.

In the connecting assembly 1, because the first insulating sleeve 12, the second insulating sleeve 13 and the third insulating sleeve 14 are independent components, and the first insulating sleeve 12, the second insulating sleeve 13 and the third insulating sleeve 14 segmentally cover different parts of the busbar 11, so that the first insulating sleeve 12, the second insulating sleeve 13 and the third insulating sleeve 14 each have a shorter length and less portion required to be bent, thereby facilitating the first insulating sleeve 12, the second insulating sleeve 13 and the third insulating sleeve 14 to be respectively sheathed on the different parts of the busbar 11, therefore the structure of the first insulating sleeve 12, the second insulating sleeve 13 and the third insulating sleeve 14 are simplified, and the manufacturing cost is greatly reduced.

After the first insulating sleeve 12, the second insulating sleeve 13 and the third insulating sleeve 14 to be respectively sheathed on the different parts of the busbar 11, because the first insulating sleeve 12, the second insulating sleeve 13 and the third insulating sleeve 14 each have insulation property, and the first insulating sleeve 12, the second insulating sleeve 13 and the third insulating sleeve 14 each have a shorter length and less portion required to be bent, in the process that the different parts of the busbar 11 are respectively sheathed with the first insulating sleeve 12, the second insulating sleeve 13 and the third insulating sleeve 14, it reduces the wearing of the first insulating sleeve 12, the second insulating sleeve 13 and the third insulating sleeve 14 caused by the busbar 11, thereby improving the insulation withstand-voltage reliability of the entire connecting assembly 1, and in turn ensuring that the connecting assembly 1 satisfies the insulation withstand-voltage reliability requirement of the battery pack.

The first insulating sleeve 12, the second insulating sleeve 13 and the third insulating sleeve 14 all may be made of an insulating material. Specifically, the insulating material may be PVC, the resin of ABS, EVA or PET. It should be noted that, the materials of the first insulating sleeve 12, the second insulating sleeve 13 and the third insulating sleeve 14 may be the same or different, as long as they meet the requirement of insulation use.

Because the heat shrinkable tube has a special property of heat shrinkage and is convenient to use, the first insulating sleeve 12, the second insulating sleeve 13 and the third insulating sleeve 14 each may be a heat shrinkable tube. The process that the different parts of the busbar 11 are respectively sheathed with the first insulating sleeve 12, the second insulating sleeve 13 and the third insulating sleeve 14 is described as follows.

When the first insulating sleeve 12 and the second insulating sleeve 13 are in a cooling state, firstly the first insulating sleeve 12 is sheathed on the main body portion 111 of the busbar 11, the second insulating sleeve 13 is sequentially sheathed on the extending portion 112 of the busbar 11, and then the first insulating sleeve 12 and the second insulating sleeve 13 are heated to make them shrunk in place; then, when the third insulating sleeve 14 is in a cooling state, firstly the third insulating sleeve 14 is sheathed on the bent connection portion 113 of the busbar 11, and then the third insulating sleeve 14 is heated to make it shrunk in place. Thus, the first insulating sleeve 12, the second insulating sleeve 13 and the third insulating sleeve 14 all are sheathed on the busbar 11 in place.

Referring to FIG. 2, FIG. 4 and FIG. 5, the main body portion 111 of the busbar 11 extends in the transversal direction X and is formed as a rectangular structure (i.e., the parts of the main body portion 111 are equal in cross-sectional area), and the thickness direction of the main body portion 111 is the longitudinal direction Y, the width direction of the main body portion 111 is the up-down direction Z. Correspondingly, the first insulating sleeve 12 is also formed as a rectangular structure (i.e., the parts of the first insulating sleeve 12 are equal in cross-sectional area). Here, because the parts of the first insulating sleeve 12 in cross-sectional area are uniform and the structure of the first insulating sleeve 12 is simple, therefore it facilitates the first insulating sleeve 12 to be sheathed on the main body portion 111, and there is no wrinkles and air bubbles when the first insulating sleeve 12 shrinks, thereby ensuring the insulation withstand-voltage reliability of the main body portion 111.

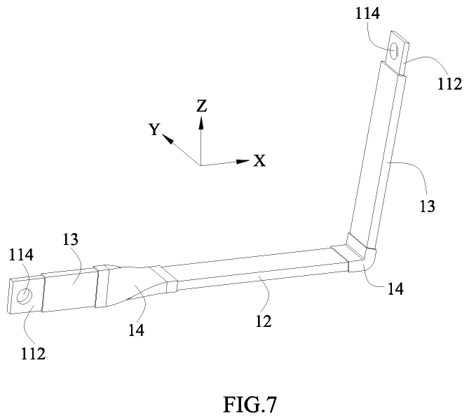

The extending portion 112 of the busbar 11 may be formed as a rectangular structure (as shown in FIG. 6 and FIG. 7). Correspondingly, the second insulating sleeve 13 may also be formed as a rectangular structure (i.e., the parts of the second insulating sleeve 13 are equal in cross-sectional area), and the second insulating sleeve 13 covers a part of the extending portion 112. In other words, a part of the extending portion 112 extends out of the second insulating sleeve 13. The connecting hole 114 is provided through the part of the extending portion 112 extending out of the second insulating sleeve 13, so that the busbar 11 connects the first battery module 2 and the second battery module 3 with the connecting hole 114. Here, because the parts of the second insulating sleeve 13 in cross-sectional area are uniform, and the structure of the second insulating sleeve 13 is simple, therefore it facilitates the second insulating sleeve 13 to be sheathed on the extending portion 112, and there is no wrinkles and air bubbles when the second insulating sleeve 13 shrinks, thereby ensuring the insulation withstand-voltage reliability of the extending portion 112.

The extending portion 112 of the busbar 11 may comprise a straight section 112A, a bent connection section 112B, and an extending section 112C (i.e., the extending portion 112 is formed as a L-shaped structure). The straight section 112A is directly connected to the bent connection portion 113, and the bent connection section 112B connects the straight section 112A and the extending section 112C. Correspondingly, the second insulating sleeve 13 may comprise a fourth covering portion 131 and a fifth covering portion 132, the fourth covering portion 131 covers the straight section 112A of the extending portion 112, and the fifth covering portion 132 covers the bent connection section 112B of the extending portion 112. The connecting hole 114 penetrates the extending section 112C of the extending portion 112, so that the busbar 11 connects the first battery module 2 and the second battery module 3 with the connecting hole 114.

Here, because the second insulating sleeve 13 only covers the straight section 112A and the bent connection section 112B of the extending portion 112, the length of the second insulating sleeve 13 is shorter and it facilitates the second insulating sleeve 13 to be sheathed on the extending portion 112, and the second insulating sleeve 13 receives less resistance when the second insulating sleeve 13 shrinks, thereby improving the shrink effect of the second insulating sleeve 13, therefore it ensures the insulation withstand-voltage reliability of the extending portion 112.

The extending portion 112 of the busbar 11 may be provided as two in number. Referring to FIG. 5, the straight section 112A of the extending portion 112 may extend in the up-down direction Z, and the extending section 112C may extend in the longitudinal direction Y. Based on the different bending direction of the bent connection section 112B with respect to the straight section 112A, the bent connection section 112B of the extending portion 112 may be formed as a horizontal bending structure, a vertical bending structure or a twisting structure.

The bent connection portion 113 of the busbar 11 and the second insulating sleeve 13 are identical to the extending portion 112 in number. Based on the different bending direction of the bent connection portion 113 with respect to the main body portion 111, the bent connection portion 113 may be formed as a horizontal bending structure, a vertical bending structure or a twisting structure. However, regardless what kind structure form of the bent connection portion 113 is formed, the structure of the third insulating sleeve 14 is always consistent with the structure of the bent connection portion 113.

Hereinafter the bent connection portion 113 will be taken as an example, and the specific structural forms of the horizontal bending structure, the vertical bending structure and the twisting structure will be described in combination with the corresponding figures.

When the main body portion 111 of the busbar 11 is a rectangular structure, the main body portion 111 has a large surface and a narrow surface, and the bent connection portion 113 may be bent with respect to the large surface of the main body portion 111 to form the horizontal bending structure (the structure shown by the bent connection portion 113 located at the lower side in FIG. 6 and the bent connection portion 113 located at the right side in FIG. 7); the bent connection portion 113 may be bent with respect to the narrow surface of the main body portion 111 to form the vertical bending structure (the structure shown by the bent connection portion 113 located at the upper side in FIG. 6 and the bent connection portion 113 in FIG. 5); the bent connection portion 113 may also be twisted with respect to the large surface and the narrow surface of the main body portion 111 to form the twisting structure (the structure shown by the bent connection portion 113 located at the left side in FIG. 7).

Because the third insulating sleeve 14 only covers the bent connection portion 113 of the busbar 11, the length of the third insulating sleeve 14 is shorter and it facilitates the third insulating sleeve 14 to be sheathed on the bent connection portion 113, and the third insulating sleeve 14 receives less resistance when the third insulating sleeve 14 shrinks, thereby improving the shrink effect of the third insulating sleeve 14, therefore it ensures the insulation withstand-voltage reliability of the bent connection portion 113.

The third insulating sleeve 14 may be wholly located between the first insulating sleeve 12 and the second insulating sleeve 13 (i.e., the third insulating sleeve 14 only covers the bent connection portion 113 of the busbar 11). At this time, in order to ensure the whole insulation withstand-voltage reliability of the connecting assembly 1, the third insulating sleeve 14 can be hermetically spliced together with the first insulating sleeve 12 and the second insulating sleeve 13 under the action of heat. The inner diameter of the first covering portion 141 is equal to the inner diameter of the first insulating sleeve 12 and the inner diameter of the second insulating sleeve 13.

Referring to FIG. 2 to FIG. 4, the third insulating sleeve 14 may further comprise a second covering portion 142, and the second covering portion 142 is connected to the first covering portion 141 and covers a part of the first insulating sleeve 12. At this time, the inner diameter of the second covering portion 142 is larger than the inner diameter of the first insulating sleeve 12. Because the second covering portion 142 of the third insulating sleeve 14 has a certain length of overlap with the first insulating sleeve 12, the insulation withstand-voltage reliability of them at the joint are improved; and at the same time, because the second covering portion 142 covers the part of the first insulating sleeve 12, there is a gap between the first covering portion 141 and the bent connection portion 113, thereby reducing the friction between the first covering portion 141 and the busbar 11, thus the first covering portion 141 can produce a greater degree of shrink, so that the first covering portion 141 does not cause the phenomena of whiteness and tearing, thereby ensuring the whole insulation withstand-voltage reliability of the connecting assembly 1.

Referring to FIG. 2 to FIG. 4, the third insulating sleeve 14 may further comprise a third covering portion 143, and the third covering portion 143 is connected to the first covering portion 141 and covers a part of the second insulating sleeve 13. At this time, the inner diameter of the third covering portion 143 is larger than the inner diameter of the second insulating sleeve 13. Because the third covering portion 143 of the third insulating sleeve 14 has a certain length of overlap with the second insulating sleeve 13, the insulation withstand-voltage reliability of them at the joint is improved; and at the same time, because the third covering portion 143 covers the part of the second insulating sleeve 13, so that there is a gap between the first covering portion 141 and the bent connection portion 113, thereby reducing the friction between the first covering portion 141 and the busbar 11, thus the first covering portion 141 can produce a greater degree of shrink, so that the first covering portion 141 does not cause the phenomena of whiteness and tearing, thereby ensuring the insulation whole withstand-voltage reliability of the connecting assembly 1.

Referring to FIG. 1, the first battery module 2 may comprise a plurality of first batteries, a first output connecting piece 21 and a first end plate 22, and one end of the first output connecting piece 21 is electrically connected to the plurality of first batteries, the other end of the first output connecting piece 21 is supported on the first end plate 22 and electrically connected to one extending portion 112 of the busbar 11. The connecting assembly 1 can also be used to realize the series and/or parallel connection between the plurality of first batteries.

Referring to FIG. 1, the second battery module 3 may comprise a plurality of second batteries, a second output connecting piece 31 and a second end plate 32, and one end of the second output connecting piece 31 is electrically connected to the plurality of second batteries, the other end of the second output connecting piece 31 is supported on the second end plate 32 and electrically connected to another extending portion 112 of the busbar 11. The connecting assembly 1 can also be used to realize the series and/or parallel connection between the plurality of second batteries.

What is claimed is:

1. A connecting assembly, comprising a busbar, a first insulating sleeve, a second insulating sleeve and a third insulating sleeve;
the busbar comprising a main body portion, an extending portion, and a bent connection portion, the bent connection portion connecting the main body portion and the extending portion;
the first insulating sleeve covering the main body portion of the busbar;
the second insulating sleeve covering the extending portion of the busbar;
the third insulating sleeve comprising a first covering portion, and the first covering portion covering the bent connection portion of the busbar.

2. The connecting assembly according to claim 1, wherein the first insulating sleeve, the second insulating sleeve and the third insulating sleeve each are a heat shrinkable tube.

3. The connecting assembly according to claim 1, wherein the third insulating sleeve is wholly located between the first insulating sleeve and the second insulating sleeve.

4. The connecting assembly according to claim 1, wherein the third insulating sleeve further comprises a second covering portion, and the second covering portion is connected to the first covering portion and covers a part of the first insulating sleeve.

5. The connecting assembly according to claim 1, wherein the third insulating sleeve further comprises a third covering portion, and the third covering portion is connected to the first covering portion and covers a part of the second insulating sleeve.

6. The connecting assembly according to claim 1, wherein
the extending portion is formed as a rectangular structure;
correspondingly, the second insulating sleeve is also formed as a rectangular structure, and the second insulating sleeve covers a part of the extending portion.

7. The connecting assembly according to claim 1, wherein
the extending portion comprises a straight section, a bent connection section and an extending section, the straight section is connected to the bent connection portion, the bent connection section connects the straight section and the extending section;
the second insulating sleeve comprises a fourth covering portion and a fifth covering portion, the fourth covering portion covers the straight section of the extending portion, the fifth covering portion covers the bent connection section of the extending portion.

8. The connecting assembly according to claim 1, wherein the busbar further comprises a connecting hole, and the connecting hole is provided through the extending portion.

9. A battery pack, comprising a first battery module, a second battery module and a connecting assembly, wherein
the connecting assembly comprises a busbar, a first insulating sleeve, a second insulating sleeve and a third insulating sleeve;
the busbar comprises a main body portion, an extending portion, and a bent connection portion, the bent connection portion connecting the main body portion and the extending portion;
the first insulating sleeve covers the main body portion of the busbar;
the second insulating sleeve covers the extending portion of the busbar;
the third insulating sleeve comprises a first covering portion, and the first covering portion covers the bent connection portion of the busbar;
the first battery module is electrically connected to the second battery module via the connecting assembly.

10. The battery pack according to claim 9, wherein the first insulating sleeve, the second insulating sleeve and the third insulating sleeve each are a heat shrinkable tube.

11. The battery pack according to claim 9, wherein the third insulating sleeve is wholly located between the first insulating sleeve and the second insulating sleeve.

12. The battery pack according to claim 9, wherein the third insulating sleeve further comprises a second covering portion, and the second covering portion is connected to the first covering portion and covers a part of the first insulating sleeve.

13. The battery pack according to claim 9, wherein the third insulating sleeve further comprises a third covering portion, and the third covering portion is connected to the first covering portion and covers a part of the second insulating sleeve.

14. The battery pack according to claim 9, wherein
the extending portion is formed as a rectangular structure;
correspondingly, the second insulating sleeve is also formed as a rectangular structure, and the second insulating sleeve covers a part of the extending portion.

15. The battery pack according to claim 9, wherein
the extending portion comprises a straight section, a bent connection section and an extending section, the straight section is connected to the bent connection portion, the bent connection section connects the straight section and the extending section;
the second insulating sleeve comprises a fourth covering portion and a fifth covering portion, the fourth covering portion covers the straight section of the extending portion, the fifth covering portion covers the bent connection section of the extending portion.

16. The battery pack according to claim 9, wherein the busbar further comprises a connecting hole, and the connecting hole is provided through the extending portion.

17. The battery pack according to claim 9, wherein
the first battery module comprises a plurality of first batteries, a first output connecting piece and a first end plate, and one end of the first output connecting piece is electrically connected to the plurality of first batteries, the other end of the first output connecting piece is supported on the first end plate and electrically connected to the busbar;
the second battery module comprises a plurality of second batteries, a second output connecting piece and a second end plate, and one end of the second output connecting piece is electrically connected to the plurality of second batteries, the other end of the second output connecting piece is supported on the second end plate and electrically connected to the busbar.
